(19) United States
(12) Patent Application Publication
(10) Pub. No.: US 2019/0154633 A1
(43) Pub. Date: May 23, 2019

(54) TEST BENCH AND METHOD FOR ESTIMATING REMANENT MAGNETISATIONS ON SEDIMENT CORES

(71) Applicants: CENTRE NATIONAL DE LA RECHERCHE SCIENTIFIQUE, Paris (FR); UNIVERSITÉ D'AIX-MARSEILLE, Marseille Cedex 07 (FR)

(72) Inventors: François Fernand Emile Alain Demory, Marseille (FR); Yoann Quesnel, La Fare Les Oliviers (FR); Minoru Uehara, Aix-en-Provence (FR); Pierre Rochette, Eguilles (FR)

(21) Appl. No.: 16/091,744

(22) PCT Filed: Apr. 10, 2017
(86) PCT No.: PCT/EP2017/058489

§ 371 Date: Oct. 5, 2018

(30) Foreign Application Priority Data
Apr. 8, 2016 (FR) 1653142

(51) Int. Cl. G01N 27/80; E21B 49/02

(52) U.S. Cl. CPC G01N 27/80; E21B 49/02

(57) ABSTRACT

According to an aspect of the invention based on a bench for testing (1) the magnetic field of portions (101) of a sediment core (100) extending along a main direction, characterised in that the test bench (1) comprises at least:
one device for moving the sediment core (100) in translation within the test bench (1),
one measuring chamber (30) comprising a fluxgate probe (40) arranged to be arranged opposite a portion (101) of sediment core (100) so as to measure the magnetic field of said portion (101) of sediment core (100) situated opposite the fluxgate probe (40);
   and that the movement device is configured so as to make the sediment core (100) translate with respect to the fluxgate probe (40) such that the fluxgate probe (40) successively measures the magnetic field of a succession of portions (101) of the sediment core (100).

The invention is also based on a method and a device for estimating the remanent magnetisations of portions of a sediment sample.

### TECHNICAL FIELD OF THE INVENTION

The present invention is generally based on magnetism applied to geosciences. It relates to the quantification of magnetisation of a sediment sample and more specifically, to the quantification of the variation of remanent magnetisations along a portion of sediment core.

For example, the invention has a particularly advantageous application in the fields of paleoclimatology, paleoenvironments and sediment stratigraphy in the broad sense, including the detection of levels, rich in particles coming from metal pollutants.

### STATE OF THE ART

Environmental magnetism is more and more used in very varied scientific studies, for example in the fields of paleoclimatology, paleoenvironments and sediment stratigraphy in the broad sense.

It is often very useful to estimate magnetisations of samples which are presented in the form of a sediment core.

A sediment core is often presented in the form of a core extending along a main direction, subsequently called long axis, and which has a constant cross-section along this axis.

The sediment core comprises at least one sediment portion obtained by core sampling. Often, it also comprises a gutter, for example made of plastic, with a U-shaped cross-section. The sides of the U can have an identical length, or not. When this is the case, each side of the U measures, for example, 2 cm (10⁻² metres). The length of the sediment core, in other words, the dimension thereof along the long axis thereof, measures around 1.5 m.

The gutter is filled by the sediment. A cover is also present. The gutter and the cover thus form a protective casing, preferably closed, to encapsulate the sediment.

Such a sediment core is commonly qualified by the term, “U-channel”.

The variation of the remanent magnetisation along a sediment core depends on the conditions of sediment deposits and therefore the climate, tectonic conditions, and the composition of grains being deposited.

It is very often useful to estimate the remanent magnetisations continuously along sediment cores to characterise the carriers of the magnetisation in the successive sediment layers that they contain.

The remanent magnetisation is, for example, generated by passing a sediment core into a Halbach array.

Usually, the techniques implemented to estimate the remanent magnetisations use superconducting magnetometers. These techniques have several disadvantages.

Current magnetometers combine an acquisition of remanent magnetisations, parallel to the long axis of the sediment core and a system for measuring with probes placed far from the sediment core (superconducting probes).

The acquisition of the remanent magnetisation parallel to the long axis of the portion of sediment core, therefore perpendicular to the sediment laminations involves a smoothing of the signal. In addition, the significant distance of the probes does not enable to characterise the remanent magnetisation with a satisfactory spatial resolution.

An aim of the present invention is to propose a solution to provide an acquisition and a measurement of remanent magnetisations of which the spatial resolution is improved.

Another aim of the present invention is to achieve this aim while reducing the cost or without significantly increasing the cost of current solutions.

Other aims, characteristics and advantages of the present invention will appear upon examining the following description and the accompanying drawings. It is understood that other advantages can be incorporated.

### SUMMARY OF THE INVENTION

According to an embodiment, the invention is based on a test bench of the magnetic field of a sediment core extending along a main direction, called long axis, the test bench comprising at least:
one device for moving the sediment core in translation within the test bench,
one measuring chamber comprising a fluxgate probe to be arranged opposite and preferably in contact with a portion of sediment core so as to measure the magnetic field of said portion of sediment core situated opposite the fluxgate probe.

The movement device is configured so as to make the sediment core translate with respect to the fluxgate probe, such that the fluxgate probe successively measures the magnetic field of a succession of portions of the sediment core.

The movement device is configured so as to make the sediment core translate with respect to the fluxgate probe such that the fluxgate probe is successively situated in the magnetic field of a succession of portions of the sediment core. The bench is configured such that the fluxgate probe measures the magnetic field almost continuously along the sediment core.

Another aspect of the present invention relates to a method for estimating the remanent magnetisations of portions of a sediment core extending along a main direction, the method comprising at least the following steps:
i. Defining a succession of N elementary volumes (corresponding to the sediment laminations) and the dimensions thereof, each elementary volume corresponding to a portion of sediment core, the elementary volumes being adjacent and successively arranged along said main direction of the sediment core;
ii. Translating the sediment core relative to a fluxgate probe so as to make each elementary volume pass opposite the fluxgate probe;
iii. Measuring, by the fluxgate probe, the magnetic field produced by each elementary volume;
iv. By using the magnetic field measurements of the fluxgate probe: determining a remanent magnetisation M₋ₓ specific to each elementary volume, this step comprising at least one from among the following steps;
   “directly” identifying a plurality of possible values of remanent magnetisation M₋ₓ, this first identification comprising:
      calculating values of magnetic field B₋ₓ from a plurality of values of remanent magnetisation M₋ₓ selected arbitrarily;
      identifying, among said plurality of values of remanent magnetisations M₋ₓ selected arbitrarily, one or more values of remanent magnetisation M₋ₓ for which the magnetic field B₋ₓ calculated is between 0.7 and 1.3 times, preferably between 0.8 and 1.2 times, and preferably between 0.9 and 1.1 times, the magnetic field B₋ₓ measured by the fluxgate probe;
   “inversely” identifying one or more values of remanent magnetisation M₋ₓ, this second identification comprising:
      calculating a value M₋ₓ of remanent magnetisation according to the measurement of the magnetic field measured by the fluxgate probe. Thus, the value M₋ₓ of remanent magnetisation is obtained by inverting the measurements of the magnetic field measured by the fluxgate probe.

Thus, according to this embodiment, either only the direct identification, or only the inverse identification, or direction identification and inverse identification can be carried out.

Preferably, the translation and measurement steps are carried out by using the test bench according to the invention.

Particularly advantageously, using a fluxgate probe combined with the other characteristics of the present invention enables to improve the spatial resolution of the sediment cores.

In the scope of development of the present invention, it has been noted that current test benches do not enable to take reliable and precise measurements on sediment cores having a strong magnetisation, whether specific or affecting the whole core. Indeed, these intense magnetisations overload superconducting magnetometers.

Indeed, during studies having been carried out regarding the present invention, the remanent magnetisations, have only been able to be acquired partially, the cross-sections of the sediment core that are the most concentrated in magnetic minerals, overloading the superconducting magnetometer.

Thus, the automated test bench according to the invention comprises a fluxgate probe. This type of probe is usually used for measuring ambient magnetic fields, but is not used for measuring remanent magnetisations.

During tests carried out in the scope of the development of the present invention, the fluxgate probe has shown an excellent sensitivity of around 1 nT. This field value is generated by “U-channels” having, according to the samples, magnetic moments of around 10⁻⁸ Am², the detection values broadly sufficient for measuring isothermal remanent magnetisations, the background noise being around 10 nT.

The sensitivity can also be increased by accumulating measurements because of the measuring speed. This sensitivity therefore enables to measure isothermal remanent magnetisations with great precision for most sediment types. An unexpected result from the preliminary study, corresponds to the fact that the spatial resolution of the fluxgate probe is better by a factor of two with respect to the superconducting magnetometers.

Moreover, this solution induces a significantly cheaper cost than that of the current solutions, in particular, solutions implementing superconducting magnetometers.

Moreover, superconducting sensors are fragile and not very transportable.

The test bench according to the invention is itself robust and a lot more easily transportable, in particular because of there being no cryogenic equipment. Moreover, the measuring chamber comprising the fluxgate probe can be separated from the profiles on which the sediment cores are moved to pass opposite the fluxgate probe. This capacity to be disassembled greatly facilitates the transportability of the test bench.

Moreover, the fluxgate probe does not overload or overloads a lot less, when the magnetisations are strong and enables to measure the fields of several dozen micro Tesla. By comparison, the magnetometers currently used are overloaded from one micro Tesla. The fluxgate probe enables therefore to estimate a broader range of magnetisation for strong-signal samples.

Moreover, the fluxgate probe enables to obtain extremely rapid measuring speeds compared with other types of magnetometers, typically around 1 m of core per minute. The measuring speed can be increased according to the measuring step.

Moreover, the fluxgate probe enables to obtain an excellent spatial resolution compared with superconducting magnetometers.

This advantage that the invention provides in terms of spatial resolution, also enables a better identification of the dipolar sources in the cores, as will be detailed below.

In the present invention, the fluxgate probe coupled with the steps of the method, enables to estimate, with an improved spatial resolution, the remanent magnetisations of different elementary volumes, each forming a portion of the sediment core.

According to another aspect, the present invention is based on a computer program product or on a non-transitory medium that can be read by a computer, comprising instructions, which when they are carried out by at least one processor, execute the steps of the method according to the invention mentioned above, in particular step iii mentioned above.

According to an advantageous, but only optional, embodiment, the step of determining a remanent magnetisation M₋ₓ specific to each elementary volume comprises at least;
said “direct” identification of a plurality of possible values of remanent magnetisation M₋ₓ, this first identification comprising:
   the calculation of values of magnetic field B₋ₓ from a plurality of values of remanent magnetisations M₋ₓ selected arbitrarily;
   the identification, from among said plurality of values of remanent magnetisations M₋ₓ selected arbitrarily, of one or more values of remanent magnetisation M₋ₓ for which the magnetic field B₋ₓ calculated is between 0.7 and 1.3 times, preferably between 0.8 and 1.2 times, and preferably between 0.9 and 1.1 times, the magnetic field B₋ₓ measured by the fluxgate probe; and
said “inverse” identification of one or more values of remanent magnetisation M₋ₓ, this second identification comprising:
   the calculation, from said one or more possible values of remanent magnetisation M₋ₓ identified coming from the “direct” identification step of a value M₋ₓ of remanent magnetisation according to the magnetic field measured by the fluxgate probe.

Thus, according to this embodiment, both direction identification and inverse identification are carried out, the possible values identified coming from the direct identification being used as input values for the inverse identification.

Advantageously, the method according to the invention can have at least one of the following optional characteristics and steps taken by themselves, or in combination.
said definition step is carried out, such that each elementary volume of sediment core has one same thickness, the thickness being measured along said main direction.
Alternatively, said definition step is carried out, such that each elementary volume of sediment core have a thickness, independent from that of the other elementary volumes, the thickness being measured along said main direction.
Preferably, said definition step is carried out, such that each elementary volume of sediment core has at least one homogeneity criterion, also called significantly homogenous sedimentological criterion, said criterion being taken from among: a colour, a texture.
According to an embodiment, the method comprises a prior step of providing a sediment core having natural remanent magnetisations, then a step of transforming the remanent magnetisations into artificial magnetisations, said transformation step comprising a passage of the sediment core into a Halbach array.

Another aspect of the present invention relates to a device for estimating remanent magnetisations of portions of a sediment sample forming a sediment core of rectangular cross-section (“U-channel”), and extending along a main direction, the device comprising a test bench according to the invention and a calculation module arranged to implement the steps of the method mentioned above, and in particular, step iv.

### BRIEF DESCRIPTION OF THE FIGURES

The aims, objectives, as well as the characteristics and advantages of the invention will best emerge from the detailed description of an embodiment of the latter, which is illustrated by the following accompanying drawings, wherein:

FIG. 1 is a schematic, perspective view of an example of a test bench according to the invention.

FIG. 2 is an enlarged view of the zone A in FIG. 1.

FIG. 3 is a top view of the test bench illustrated in FIG. 1.

FIG. 4 is a side view of the test bench illustrated in FIG. 1.

FIG. 5 is a view along the cross-section B-B of the test bench illustrated in FIG. 1.

FIG. 6 is a view along the cross-section C-C of the test bench illustrated in FIG. 1.

FIG. 7 illustrates the steps of an example of a method for estimating the remanent magnetisations according to the invention.

FIG. 8 is a schematic representation of a sample of sediments forming a sediment core.

FIG. 9 is a schematic representation of a sample of sediments forming a sediment core after passage of the sediment core into a Halbach array.

FIGS. 10 to 13 illustrate the steps of an inversion method used in the scope of the present invention.

FIG. 14 is a graph illustrating the spatial resolution of a signal emitted by a specific source measured by a test bench according to the invention on the one hand, and by a conventional superconducting magnetometer on the other hand.

FIG. 15 is a graph illustrating the spatial resolution of a signal emitted by a synthetic core measured by a test bench according to the invention on the one hand, and by a conventional superconducting magnetometer on the other hand, as well as a photograph of the synthetic core.

The drawings are given as examples and are not limiting of the invention. They constitute schematic representations, in principle intended to facilitate the understanding of the invention and are not necessarily to the scale of the practical applications. In particular, the relative thicknesses of the parts are not necessarily representative of the reality.

### DETAILED DESCRIPTION OF THE INVENTION

Before beginning a detailed review of the embodiments of the invention, below are stated the optional characteristics which can possibly be used, in association or alternatively:
the measuring chamber of the test bench comprises a magnetic shield forming a cylinder, open at each of the ends thereof inside which are situated the fluxgate probe and said portion of sediment core, preferably situated in contact or in the immediate proximity of the fluxgate probe.
the magnetic shield comprises two mu-metal layers. Each layer forms a sleeve. The two sleeves are concentric.
the movement device comprises a conveyor belt, driven in movement by a motor, and wherein the conveyor belt passes through the measuring chamber.
the motor is a stepper motor. Preferably, the step is around 560 micrometres.
the distance between the fluxgate probe and the portion of sediment core is less than or equal to 6 mm (10⁻³ metres), preferably less than or equal to 2 mm, preferably less than or equal to 1 mm, preferably equal to 0 mm.
the fluxgate probe comprises a core. The core is preferably made of permalloy. The core is usually surrounded, at least partially, by one or more coils. The permalloy is a range of alloys with high permittivity. The permalloy is a range of alloys with nickel and iron-based magnetic properties, and also often, in lesser proportions, of molybdenum and of manganese.
The distance between the core and the portion of sediment core is less than or equal to 6 mm (10⁻³ metres), preferably less than or equal to 2 mm, preferably less than or equal to 1 mm, preferably equal to 0 mm.
The fluxgate probe comprises a valve and the distance between the valve and the portion of sediment core is less than or equal to 6 mm (10⁻³ metres), preferably less than or equal to 2 mm, preferably less than or equal to 1 mm, preferably equal to 0 mm.
These distances enable to perfectly control the distance between the fluxgate probe and the sample. In particular, according to an embodiment, the value or the core are preferably not housed in a casing. This enables to approach the core or the valve of the sample, as close as possible. This enables to improve the spatial resolution. Moreover, this enables to have a lower detection threshold.
the step of determining a remanent magnetisation M₋ₓ specific to each elementary volume comprises at least;
   said “direct” identification, and
   said “inverse” identification.

Moreover, the calculation of said value M₋ₓ of remanent magnetisation according to the magnetic field measured by the fluxgate probe made during said “inverse” identification, is made from one or more of said possible values of remanent magnetisation M₋ₓ identified coming from the “direct” identification step. This embodiment enables to obtain clearly specific results in a considerably reduced time.
The remanent magnetisations are artificial remanent magnetisations, preferably isothermal.
the sediment core has a square cross-section of 2 cm on the side and a length equal to or less than 1.5 m.
the fluxgate probe is arranged to be arranged in contact with the sediment core.
the fluxgate probe is arranged to be arranged perpendicularly to the long axis of the sediment core so as to measure the magnetic field produced locally by the portion of sediment core. The fluxgate probe is arranged to measure the magnetisation, perpendicularly to the long axis of the core.
the fluxgate probe is configured to measure, perpendicularly to said main direction, the magnetic field generated by said portion of sediment core.
the fluxgate probe is arranged so as to measure, perpendicularly to said main direction, the magnetic field generated by said portion of sediment core situated opposite the fluxgate probe.
taking measurements by the fluxgate probe is synchronised with the movement in translation of the sediment core. Thus, the fluxgate probe only takes a measurement when a movement of the sediment core is completed to bring an elementary volume to the right of the fluxgate probe.
the test bench enables specific measurements to be taken. Alternatively, it enables a measurement to be taken in scanner mode. One same test bench enables to take these two types of measurement.
the fluxgate probe is situated vertically below the sediment core when the sediment core is situated partially at least in the measuring chamber.
the movement device is configured so as to make the sediment core translate with respect to the fluxgate probe, such that the fluxgate probe measures the magnetic field produced by the successive sediment layers.
before measuring the magnetic field, the portion of sediment core is magnetised perpendicularly to the long axis thereof using a Halbach array.

In the present description, the terms sample, sediment sample or sediment core are interchangeable and mean, as indicated in the section relating to the prior art, a portion of sediment extending along a main direction and which can be partially or fully encapsulated in a casing.

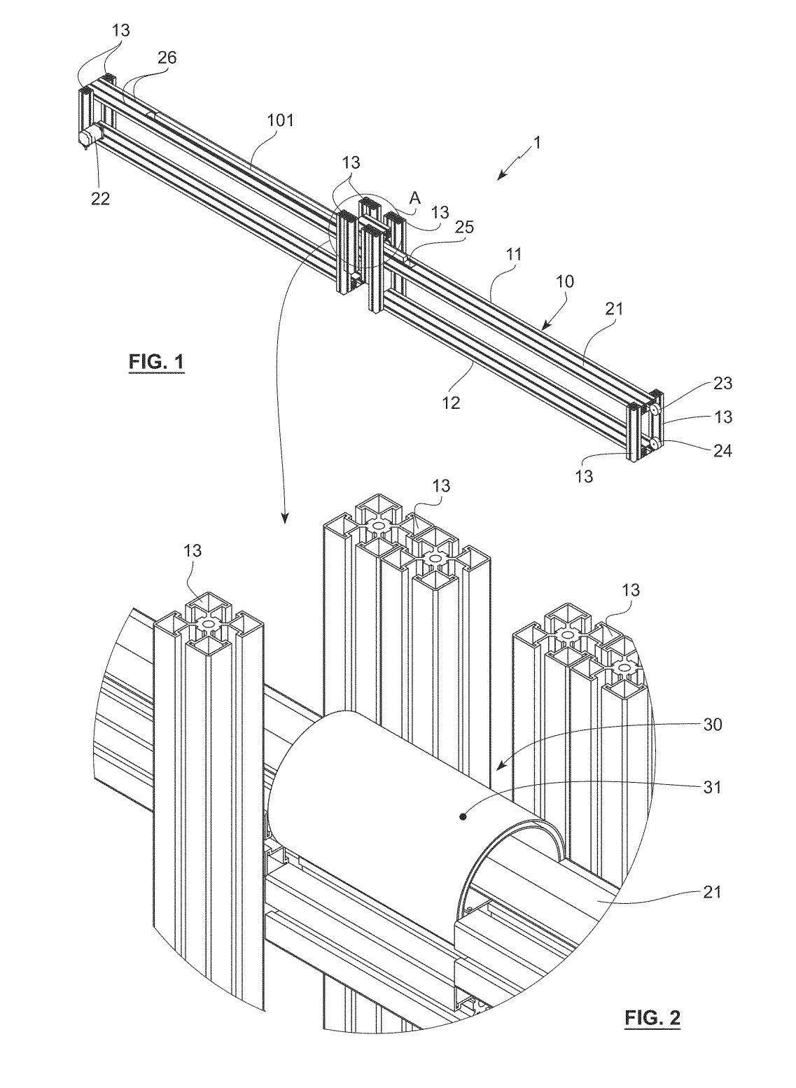

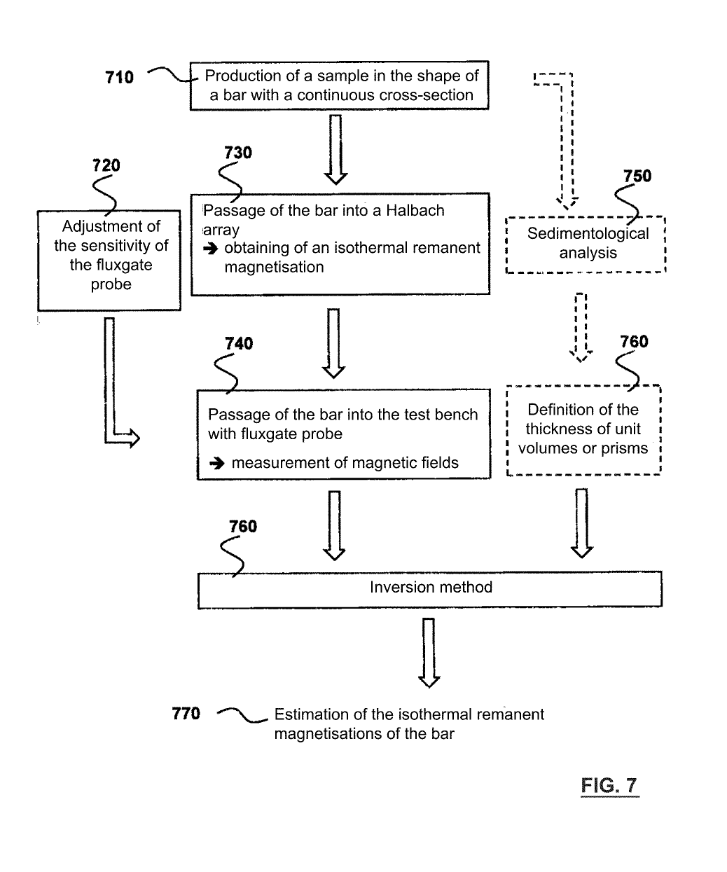

An example of a test bench according to the invention will now be defined in detail, in reference to FIGS. 1 to 6, then a method for estimating remanent magnetisations will then be presented in reference to FIGS. 7 to 13.

The test bench 1 mainly comprises an antimagnetic chamber 30 inside which is brought a sediment core 100 to measure the remanent magnetisations thereof. The antimagnetic chamber 30 is carried by a frame 10 which also comprises a device for moving the sediment core 100, in order to move the latter from the outside to the inside of the antimagnetic chamber 30.

These different elements of the test bench 1 will now be detailed.

The frame 10 comprises vertical elements 13 bearing on the work surface. These elements are, in this example, constituted of profiles, typically made of aluminium. These vertical profiles 13 support an upper beam 11, extending preferably horizontally and intended to support the sediment core 100 and the conveyor belt 21 thereof. Preferably, at least one other beam 12, preferably horizontal and lower, is secured to the vertical profiles to ensure the robustness and stability of the test bench 1.

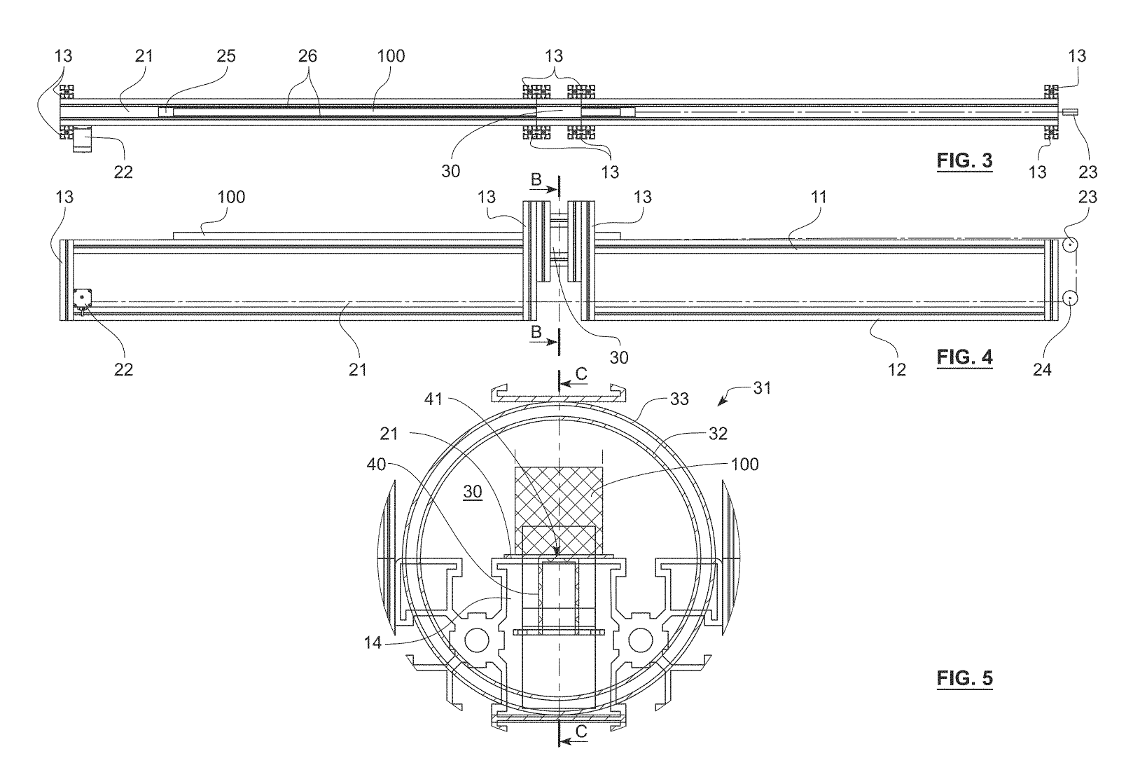

The device for moving the sediment core 100 comprises the conveyor belt 21 which extends over and along the beam 11, as well as a carriage 25 fixed to the conveyor belt 21 is on which the sediment core 100 is intended to rest by gravity. Preferably, the carriage 25 is inelastic and not very deformable. The carriage 25 extends over the whole length of the sediment core 100 and exceeds the latter as illustrated in FIGS. 1 and 3. This enables to fix the ends of the carriage 25 to the conveyor belt 21.

According to another embodiment, the sediment core 100 rests directly on the belt 21.

This conveyor belt 21 is closed or open when it is fixed to the ends of the carriage 25. It is driven in movement by a motor 22, preferably a stepper motor, secured to the frame 10.

Preferably, pulleys 23, 24 are arranged on the frame 10 to guide the conveyor belt 21 by making a right angle from the upper beam 11 towards the lower beam 12. Thus, the conveyor belt 21, when it comes to the end of the upper beam 11, goes back between the upper 11 and lower 12 beams, in an inverse direction, until the motor 22. The conveyor belt 21 thus enables a translation of the sediment core 100.

Advantageously, the test bench comprises guides 26, configured to guide the translation of the sediment core 100 by avoiding the movement thereof, transversally to the provided direction of translation. Two guides 26 are thus arranged on either side of the belt 21 and of the carriage 25, as illustrated in FIGS. 1 and 3.

Preferably, at the middle of the upper beam 11, the frame 10 supports the antimagnetic chamber 30. The antimagnetic chamber 30 comprises an inlet and an outlet. It is passed through, from one end to the other, by the sediment core 100 when the latter translates.

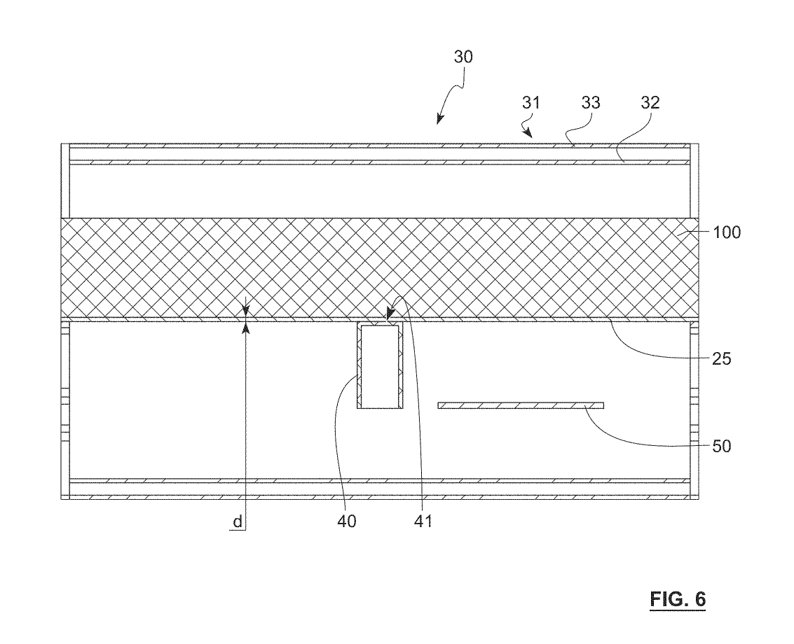

The antimagnetic chamber 30 comprises a magnetic shield 31 configured to prevent outside magnetic disturbances interfering with the inside of the antimagnetic chamber 30. This shield 31 typically comprises an inner layer 31 and an outer layer 32, each forming a cylindrical sleeve. Preferably, each of the layers 31, 32 is made of mu-metal. These cylindrical sleeves appear in the cross-section in FIGS. 5 and 6.

At the level of the antimagnetic chamber 30, the upper beam 11 is discontinuous. The antimagnetic chamber 30 forms a housing 14 configured to contain a magnetic field sensor, also called a magnetometer. This magnetometer is a fluxgate probe 40. In FIGS. 5 and 6, for reasons of clarity, only one casing of the fluxgate probe is illustrated.

The fluxgate probe 40 is situated vertically below the sediment core 100 when the sediment core is situated partially at least in the measuring chamber 30.

This type of probe is used for measuring ambient magnetic fields, for example the ambient magnetic field of a part. However, as indicated above, in known solutions, this type of probe is never used for measuring the magnetic field of a sediment core, “U-channel”, and deducts the remanent magnetisations from it. As will appear in the description which follows, the use of this fluxgate probe gives numerous advantages.

Advantageously, the sediment core 100 translates continuously by passing opposite the fluxgate probe 40. Moreover, taking measurements by the fluxgate probe 40 is synchronised with the movement in translation of the sediment core. Thus, it is possible to precisely trigger a measurement by the fluxgate probe 40 for each of the portions 101 of the sediment core 100.

Thus, the movement of the sediment core is made continuously. A measurement can be taken at regular intervals, for example, every 560 μm. This enables to analyse, in 45 seconds, 1 linear metre of sediment core. This duration of analysis can be reduced by increasing the translation speed of the core. Thus, at each linear section of the core, one single measurement is taken. The core is not driven in translation around the long axis thereof. The magnetic field which is captured by the fluxgate probe corresponds to the magnetic field of the portion located opposite the fluxgate probe.

According to an alternative embodiment, it can be provided to immobilise the core 100, in order to take each of the measurements by the fluxgate probe 40. Thus, at the end of movement of the sediment core to bring an elementary volume to the right of the fluxgate probe, the latter takes a measurement.

The test bench selectively enables a specific measurement to be taken, or for it to be put in scanner mode.

In reference to FIG. 7, the main steps, not necessarily essential, of an example of the method according to the invention will now be detailed.

A first step (step 710) consists of providing a sample in the form of a sediment core, for example, with a continuous cross-section. This sediment core is typically obtained by core sampling in a sediment layer, then encapsulation in a protective casing.

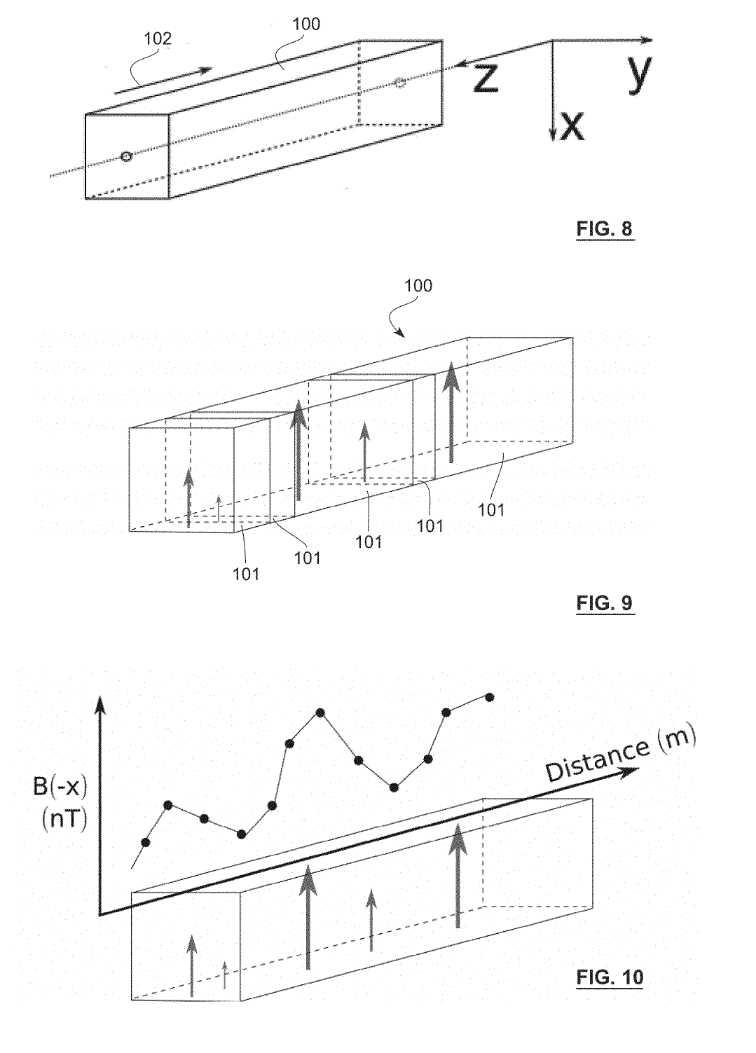

Such a sediment core is illustrated in FIG. 8. In this FIG. 8, a marker (x, y, z) is also represented, wherein:
x, positive axis towards the bottom and perpendicular (transversal) to the main direction along which the sediment core 100 extends;
y, positive axis towards the user of the invention, perpendicular (transversal) to the main direction along which the sediment core 100 extends;
z, main direction along which the sediment core 100 extends, positive in the opposite direction to the movement of the sediment core 100 during the measurement.

The direction of movement 102 of the sediment core 100 is illustrated in FIG. 8.

In step 730 illustrated in FIG. 7, the sediment core 100 is then treated to make it lose the natural magnetisation thereof and to transform it into a remanent magnetisation. For this, the sediment core is passed into a Halbach array, of which the properties well-known to a person skilled in the art of environmental magnetism, are for example defined in the following publication, Rochette, P., Vadeboin, F., Clochard, L., 2001. Rock magnetic applications of Halbach cylinders, Physics of the Earth and Planetary Interiors 126, 109-117.

The passage of the sample into the Halbach array creates the remanent magnetisation, it is therefore a preliminary passage to measure the field generated by this artificial magnetisation. During the passage of the sediment core into the Halbach array, the latter leads to an overloading of magnetisation of the sediments in a predetermined direction (here −x). The other magnetisations are removed by re-magnetisation in the Halbach array, except for it there is a signal with a high coercive function. Often, natural remanent magnetisation is removed during treatments coming well before the passage into the Halbach array.

FIG. 9 illustrates the distribution and the intensities of the magnetisations in the sediment core after passage into the Halbach array.

Each elementary volume 101 is considered as having an even magnetisation. Each magnetisation vector is at the centre of an elementary volume 101. The height of each arrow illustrates the intensity of the magnetic field measured for the elementary volume which is associated with it.

Then, the sediment core 100, when it is present in the antimagnetic chamber 30, is arranged in contact with the fluxgate.

The distance between the fluxgate probe and the sediment thus corresponds to the thickness of the casing which encapsulates the sediment. For example, this plastic casing has a thickness of 2 mm (10⁻³ metres). This distance is referenced “d” in FIG. 6.

If the sediment core 100 is not encapsulated in a casing, then it is the sediment which is directly in contact with the fluxgate probe. Thus, d=0.

Preferably, the fluxgate probe comprises a core. The core is preferably made of permalloy. The core and the portion of sediment core are in contact or all at least at a distance less than or equal to 6 mm (10⁻³ metres), preferably less than or equal to 2 mm, preferably less than or equal to 1 mm.

This zero distance or very low distance enables to perfectly control the distance between the fluxgate probe and the sample portion of which the magnetic field is sought to be measured. This enables to approach the core or the valve of the sample, as close as possible. This enables to improve the spatial resolution. Moreover, this enables to have a lower detection threshold.

The remanent magnetisation is acquired perpendicularly to the measuring face using the Halbach array.

Thus, the main face 41 is arranged to the right of a portion 101 of the sediment core 100. With the cross-section of the sediment core 100 being rectangular, each portion forms a rectangular elementary volume. The elementary volumes or portions are referenced in FIG. 9. In the example illustrated, the elementary volumes each form a prism.

For a relative position of the sediment core 100 with respect to the fluxgate probe 40, the latter measures a magnetic field: that corresponding mainly to the effect of magnetisation of the elementary volume 101 situated to the right of the main face 41 of the probe 40. But, the magnetisation of the adjacent elementary volumes will also impact the value of the measurement.

Typically, the dimensions of the main face 41 are as follows:
Width of 2 cm
Length of 1.5 m

The width and the length are taken along the dimensions, respectively perpendicular and parallel to the main direction along which the sediment core 100 extends (the long axis of the sediment core).

The magnetic shield 31 has a sufficiently large inner diameter to house both the fluxgate probe 40 and the portion 101 of sediment core 100 situated to the right of the main face 41 of the probe 40.

The sediment core 100 is then arranged on the test bench and oriented such that the fluxgate probe 40 measures the magnetic field of the portion 101 of the sediment core 100 arranged to the right of the main face 41 thereof. The sediment core 100 passes through the antimagnetic chamber 31. The probe 40 thus measures the magnetic field along a predefined measuring step, each measurement being therefore impacted by the portion 101 of the sediment core 100 (to the right of the sensor), but also by the adjacent portions (step 740).

The magnetic field measurements taken by the fluxgate probe 40 are then transmitted to the calculation module. The latter can be integrated into the test bench, for example, in a control module comprising a control board 50 of the test bench 1 or alternatively be moved from the latter by being in wired or wireless communication without the latter.

The magnetic field measurements taken by the fluxgate probe 40 thus constitute a first type of input data such that the calculation module determines an estimation of the remanent magnetisations.

A second type of input data is constituted by data coming from a sedimentological analysis of the sediment core forming a “U-channel”. This second type of data is based on the thickness of unit volumes forming the sediment core, the thickness of the unit volumes is taken along the main direction, along which the sediment core extends, in other words, along the axis z on the marker (x, y, z) in FIG. 8.

Following the description, the terms elementary volumes and prisms will be used interchangeably.

In the method which will subsequently be detailed, it is considered that each elementary volume has a single homogenous magnetisation, each elementary volume being sound, corresponds to a single sedimentological sequence.

These steps of defining the thickness of the elementary volumes are illustrated in 750 and 760 in FIG. 7.

The definition of these unit volumes or elementary volumes is, for example, based on an analysis of geophysical, mineralogical and sedimentological parameters if available. Thus, the sedimentologist, by visually analysing the sample, determines a succession of adjacent portions 101, also called premiums 101, which together form the sediment core 100. The thickness of each elementary volume 101 can be defined, independently of the thicknesses of the other elementary volumes 101. Alternatively, all the elementary volumes 101 have the same thickness. Insofar as possible, each cross-section has a certain homogeneity for the parameter(s) used to delimit the thickness of each elementary volume. Thus, each elementary volume 101 has a certain homogeneity in colour or texture, and has a different colour or a different texture from that of the adjacent cross-section.

This definition of the elementary volumes based on an analysis of the core enables to optimise the measuring step. It thus enables to optimise the measuring time.

The calculation module then provides an estimation of the remanent magnetisation of each elementary volume 101 of the sediment core 100.

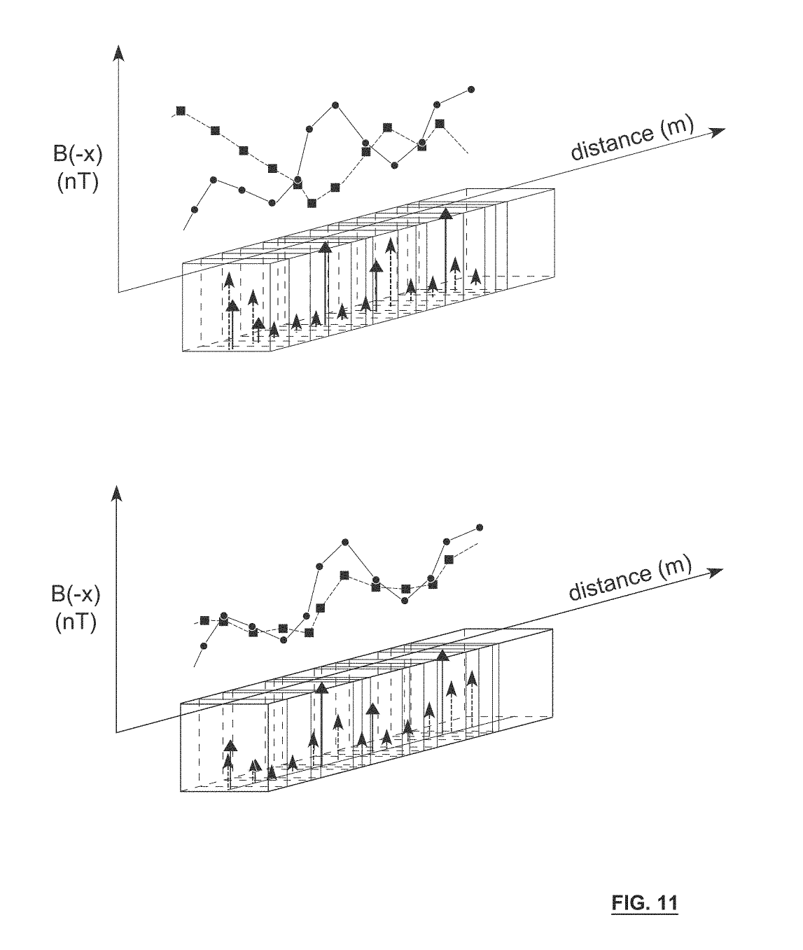

This estimation is based on a method which will now be defined in detail, in reference to FIGS. 10 to 13.

The uniaxial fluxgate probe 40 measures the magnetic field along the direction (−x), that is positively towards the top. The term B₋ₓ will be used to mean the magnetic field measured by the fluxgate probe along this direction.

As indicated above in reference to step 740 in FIG. 7 and in FIG. 9, during the passage from the sediment core 100 into the Halbach array, the latter leads to an overloading of the magnetisation of the sediments in the direction (x), but positively towards the top, that is M₋ₓ The other magnetisations are removed by the re-magnetisation in the Halbach array, except for if there is a signal with a high coercive function.

FIG. 10 illustrates the return of the magnetic fields (B₋ₓ) along the sediment core 100.

As indicated above, each sediment sequence will be assimilated to a rectangular elementary volume i (a cross-section of the sediment core), wherein one single homogenous magnetisation (M₋ₓ)ⁱ is considered. In this example, the elementary volumes each form a rectangular prism. By default, in the approach below, N elementary volumes of the same thickness are considered. However, and as indicated above, the invention extends to the embodiments enabling to limit these thicknesses by a prior visual analysis, as has been indicated in reference to steps 750, 760 in FIG. 7 and as will subsequently be detailed. The standard thickness is equal to the interval between two measurements, with the centre of each elementary volume placed under each measurement, therefore N corresponds to the number of measurements.

The method according to the invention then provides two main steps: a direction modelling step and an inversion step for finding a series of dipolar moments associated with each rectangular elementary volume.

Step 1—Direct Modelling

The first step consists of directly modelling the variations in magnetisation of the sediment core in each elementary volume by using a basic “trial and error” method. Among different possibilities of series of values M₋ₓ ((M₋ₓ)¹, (M₋ₓ)², (M₋ₓ)³, . . . , (M₋ₓ)^{N}), the algorithm will find which best predicts the observations B₋ₓ. The equation connecting a measurement B₋ₓ and a magnetised rectangular elementary volume (here along (−x)) is as follows:

$${B}_{- x} = {M}_{- x} {\sum }_{i = 1}^{2} {\sum }_{j = 1}^{2} {\sum }_{k = 1}^{2} s \cdot arctan ( \frac{{a}_{i} {b}_{j}}{{c}_{k} {R}_{ijk}} ) \qquad Equation ( 1 )$$

with i, j, k, of indices equal to 1 or 2 and delimiting the edges of the elementary volume in the directions (−y, −z, x), respectively. The coefficient s corresponds to the product (sᵢsⱼsₖ) with s₁=−1 and s₂=+1, whereas (a, b, c) are the coordinates of the corners of the elementary volume with respect to the measuring point, still along (−y, −z, x), and Rᵢⱼₖ=(a²+b²+c²)0.5.

This equation is drawn from the following publication: Plouff, D., 1976. Gravity and magnetic fields of polygonal prisms and application to magnetic terrain corrections, Geophysics, 41(4), 727-741.

The marker (−y,−z,x) comes from the fact that, in this publication, the equations are defined in a marker (N, E, vertical) whereas the invention preferably provides a specific marker for using a U-channel sample, this specific marker being defined above in reference to FIG. 8.

Each measurement B₋ₓ can be impacted by several adjacent elementary volumes. The different possibilities of magnetisation for all the elementary volumes correspond to a total of nmx^{N} cases, with nmx, the number of values tested for each elementary volume (for example: 4 values, if M₋ₓ=0.1, 1, 10 or 100 A/m is tested). The problem becomes very costly in calculation time, if the number of cases to be tested is increased (for example, a step of 0.1) in order to obtain a better search resolution. However, by remaining reasonable, a first scanning of the possible models can be quickly carried out, and then limit the possible M₋ₓ intervals for each elementary volume.

FIG. 11 illustrates the initial and final models of this step called “direct”.

In this figure, the elementary volumes have the same thickness.

Thus, a series of N values of M₋ₓ is obtained, enabling to explain all the measurements B₋ₓ quite well. This direct modelling step (i.e. the parameters M₋ₓ are used to predict the data B₋ₓ) is advantageous to then make a quicker and more robust inversion.

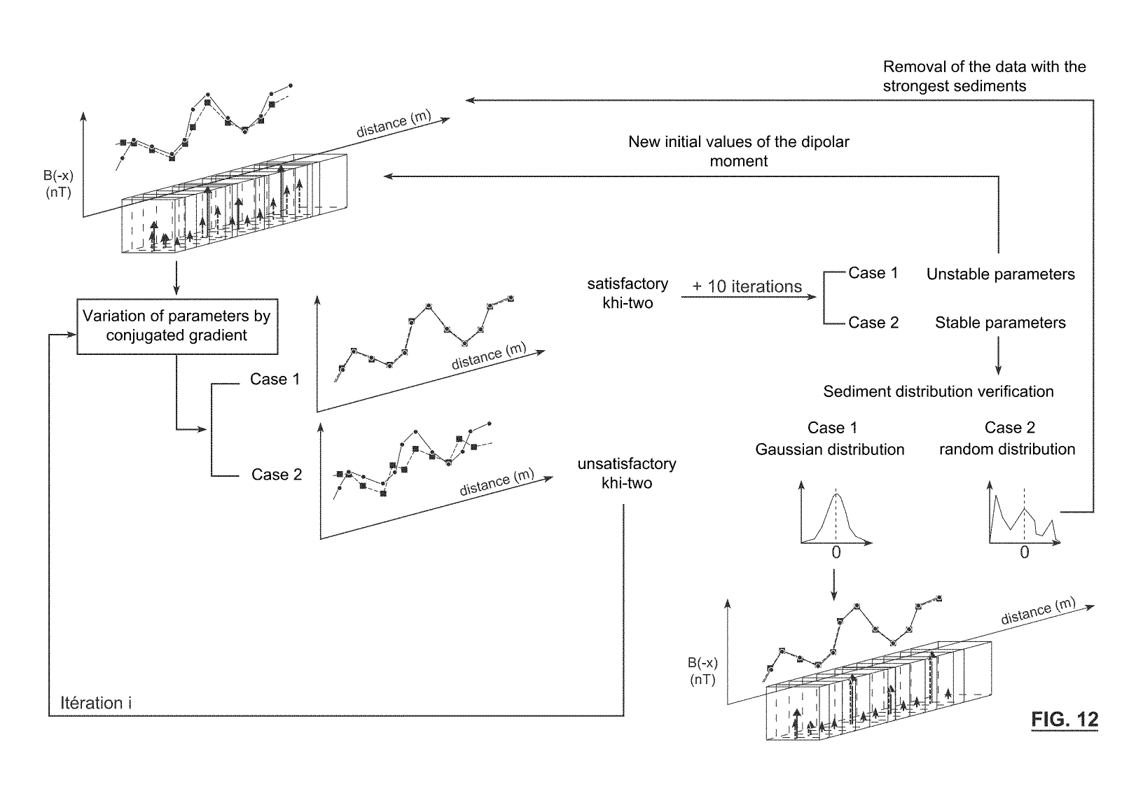

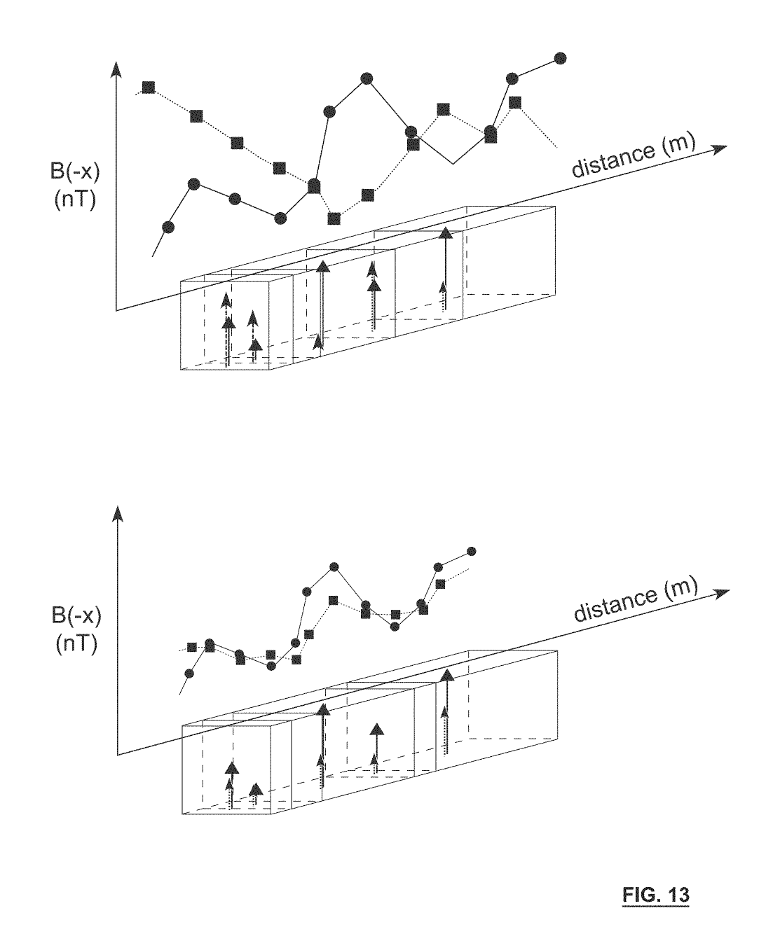

In this FIG. 11, as in FIGS. 12 and 13, the dotted-line and arrowed curve of which the body is in a dotted line, are estimated or predicted values and the curve and the solid-line arrows are the values measured by the fluxgate probe.

The figure at the top illustrates an example of modelling to be excluded. Indeed, the data predicted and the data measured are very different.

The figure at the bottom illustrates an example of possible and improvable modelling. Indeed, the data predicted and the data measured are closer than that in the figure at the top.

Step 2—Inversion to Find a Series of Dipolar Moments

The second step consists, indeed, of specifically determining all the values m₋ₓ following the elementary volumes which will best explain the data B₋ₓ, by using an inverse method. This relates to using the data B₋ₓ (input) to find the parameters m₋ₓ (output). With the equation (1) not being simply reversible, the method according to the invention provides to use the equation of a dipole:

B₋ₓ=Cₘ(3(m₋ₓ·r₋ₓ)r₋ₓ−r²·m₋ₓ)/r⁵ Equation (2)

with Cm, a proportionality factor equal to 10−7 SI, m₋ₓ, component along −x of the dipolar moment (in A·m²) of the dipole, r₋ₓ, component along −x of the vector r going from the dipole to the measurement (r=(r₋ₓ*r₋ₓ+r_{y}*r_{y}+r_{z}*r_{z})^{0.5}).

M₋ₓ corresponds to the magnetisation intensity (of each prism) in A/m.

m₋ₓ corresponds to the intensity of the moment of each dipole in A·m²

The dipolar moment corresponds to the product of the magnetisation (in A/m) by the volume considered (in m³, here the volume of a rectangular elementary volume). The analogy with a dipole actually corresponds to a concentration of the magnetisation at the centre of each elementary volume. This is a disadvantage, considering the reality of sediment sequences, but the measuring step, therefore the space between two dipoles, is sufficiently small to outweigh the inconsistency between an elementary volume and a dipole. In addition, the dipole has the advantage of an easily derivable equation, even if the relationship between B₋ₓ and m₋ₓ remains non-linear. It is to be reminded, that each measurement along the U-channel sample corresponds to the sum of several B₋ₓ, each connected to a dipole.

The whole mathematical problem is resolved by using the generalised non-linear inversion method, functioning by iterations and developed by Tarantola and Valette in the following publications:
Tarantola, A. et Valette, B., 1982. Generalized Nonlinear Inverse Problems Solved Using the Least Squares Criterion, Rev. Geophys. Sp. Phys., 20, 219-232.
Quesnel, Y., 2006. Interprétation des données magnëtiques martiennes: contraintes sur l'évolution primitive de Mars. Thèse de doctorat, Université de Nantes (Interpretation of magnetic Martian data: limitations on the primitive evolution of Mars. Doctoral thesis, University of Nantes).

This algorithm linearises equation (2) at each iteration, by using the 1^{st} degree Taylor development thereof (partial derivatives). During an iteration, the possible values of parameters (here, the series of m₋ₓ) are proposed to predict the data values (a series of predicted B₋ₓ) which are becoming sounder in explaining the true observations (the series of measured B₋ₓ). The convergence criterion is calculated by the least squares (calculation of □2). This approach works, if the number of initial data is at least equal to or greater than the number of parameters to be sought and the limitations are applied to certain parameters. This is the case, with the method according to the invention, as the number of measurement B₋ₓ is equal to the number of dipoles m₋ₓ, of which the position is perfectly known. The main equation of the problem is:

pₖ₊₁=p₀+(Gₖ^{T}·C_{d}_{₀}_{d}_{₀}⁻¹·Gₖ+Cₚ_{₀}ₚ_{₀}⁻¹)⁻¹·Gₖ^{T}·C_{d}_{₀}_{d}_{₀}⁻¹·[d₀−g(pₖ)+Gₖ·(pₖ−p₀)] Equation (3)

with pₖ₊₁ and p₀, sets of values of parameters m₋ₓ at the iteration k+1 and at the start of the inversion, respectively; Gₖ, matrix of the partial derivatives of equation (1) for the iteration k, C_{d0d0} and Cₚ₀ₚ₀, covariance matrices associated with the data B₋ₓ and with the parameters m₋ₓ; d₀ and g(pk), sets of data observed and predicted by the parameters of the preceding iteration k, respectively.

The criterion of the least squares, □2, is calculated at each step via:

$${χ}^{2} = \frac{{\sum }_{i = 1}^{N} {( \frac{( {g ( {p}_{k} )}^{i} - {d}_{0}^{i} )}{\sqrt{{C}_{{d}_{0} {d}_{0}}^{i}}} )}^{2}}{N} \qquad Equation ( 4 )$$

with N, the number of data. The iterations stop when this criterion has been low and stable for a few iterations, and that the parameters no longer vary significantly.

According to an embodiment, the invention provides different means for controlling the convergence and the calculation time of the inversion. Among these means, the method provides, for example, the adjustment of the initial standard deviations associated with the data B₋ₓ and with the parameters m₋ₓ, the calculation of the final distribution of the sediments between data and predictions, etc. But this is particularly the result of the prior direct modelling step which enables to make the algorithm rapidly converge towards a robust solution, by proposing values of m₋ₓ at the start of the inversion which are already almost ideal, by only “locally” exploring the possible values.

Thus, the values selected coming from the direct identification step, values which are therefore considered as possible, are used to begin the calculation during the inverse identification step.

According to another embodiment of the method according to the invention, the algorithm works autonomously, by optimising all these control levers as much as possible, in order to guarantee a robust result at first.

The final “mathematical” product of the inversion therefore corresponds to a series of dipoles, of which the positions are known (determined beforehand by the position of the data) and the moments (in A·m²) along (−x) determined by the inversion. If needed, the algorithm thus converts the dipolar moments into magnetisation (in A/m) by dividing each moment by the volume of an elementary volume.

FIG. 12 illustrates this second step.

According to an alternative embodiment, the method considers the thicknesses of elementary volumes defined by the user. As indicated in steps 750, 760 in FIG. 7, prior to the estimation, a prior description of the core forming the sediment core is made. This description enables to perfectly delimit all the sequences of sediment deposits in the sediment core. The number of elementary volumes (and therefore dipoles) will be different from the number of measurements. Preferably, cases where the analysis resolution enables to obtain more elementary volumes than possible measurements are excluded.

Most of the time, this visual work enables particularly to synthesise the sediment core in only a few sequences, which involves a number N of data, largely greater than the number Np of elementary volumes. Step 1 occurs as defined above, except for the fact that the number of cases to be tested is reduced, as nmx^{N} becomes nmx^{Np}.

FIG. 13 illustrates this alternative embodiment.

The figure at the bottom illustrates an example of an embodiment to be excluded. Indeed, the data predicted and the data measured are too different.

The figure at the bottom illustrates an example of possible and improvable modelling. Indeed, the data predicted and the data measured are closer than that in the figure at the bottom.

Step 2 of inversion is all as similar as the description presented above, with Np parameters for N measurements. If there are not very many elementary volumes coming from the analysis, then the fact of focusing the whole magnetisation into 1 single point (dipole) is not necessarily ideal, but this also enables in increase the convergence speed of the inversion.

As indicated above, the invention enables to obtain an excellent spatial resolution by comparison with superconducting magnetometers.

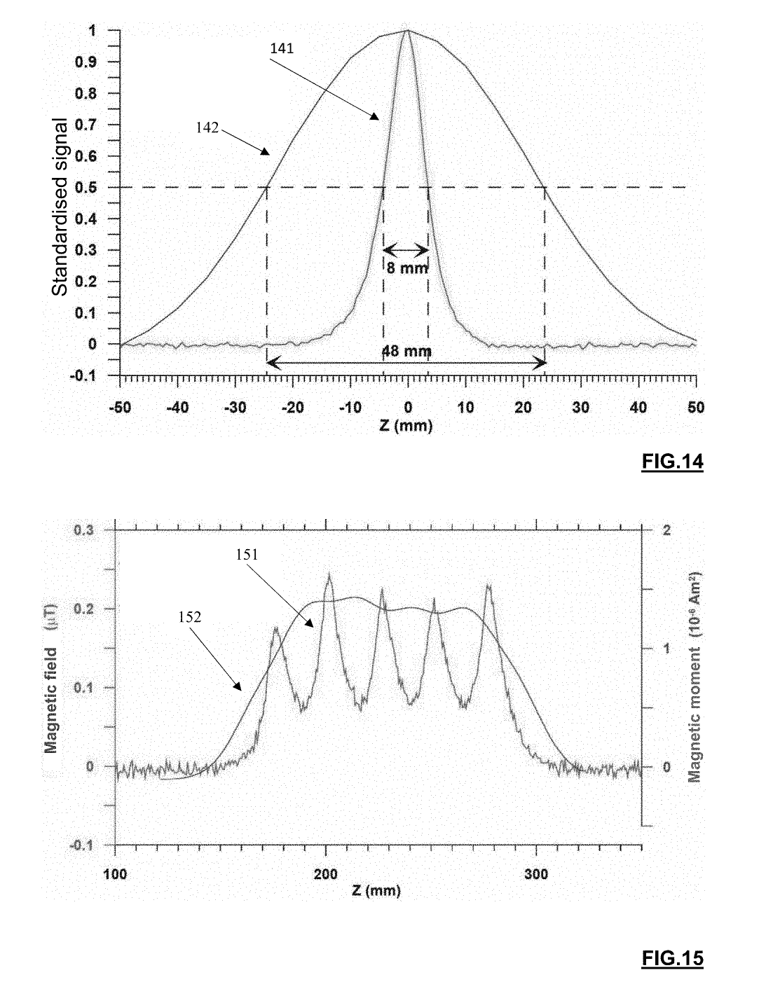

FIG. 14 clearly illustrates the gain that the invention brings in terms of spatial resolution. Indeed, in this figure, it arises that for one same core, the test bench according to the invention, equipped with a fluxgate probe, enables to obtain for a specific source, a half-peak width of around 8 mm (curve 141), whereas this width is 48 mm when the measurement is taken with a device equipped with a conventional superconducting magnetometer (curve 142).

It will be noted, that the curve 141 corresponds to a measurement (Tesla) of the magnetic field by a fluxgate probe and that the curve 142 corresponds to a measurement (Amperes·m²) of the magnetic moment by a superconducting magnetometer. The values obtained have been standardised to be more easily compared on the graph of this FIG. 14.

As illustrated in FIG. 15, this advantage that provides the invention, in terms of spatial resolution, also enables a better identification of the dipolar sources in the cores. The example in FIG. 15 clearly shows that the invention enables to identify four sources in the core (curve 151), whereas a device equipped with a superconducting magnetometer according to the prior art only shows one single peak, very broad (curve 152).

In view of the description which precedes, it clearly arises that the invention enables to provide a reliable, reproducible and simple estimation of the remanent magnetisation of sediment cores, in particular sediment cores having a strong magnetisation.

Another aim of the present invention is to propose such a solution, while reducing the cost with respect to the equipment equipped with superconducting magnetometers.

The invention is not limited to the embodiments defined above, and extends to all embodiments covered by the claims.

In particular, it extends to all types of sediment cores which extend mainly along a preferential direction. The cross-section of the core along this axis can be constant (or not).

### REFERENCES

1 Test bench
10 Frame
11 Upper horizontal beam
12 Lower horizontal beam
13 Vertical profiles
21 Conveyor belt
22 Motor
23 Upper return pulley
24 Lower return pulley
25 Carriage
26 Guide
30 Antimagnetic chamber
31 Magnetic shield
32 Inner layer
33 Outer layer
40 Fluxgate probe
41 Main face
50 Control board
100 Sediment core
101 Portion of sample or elementary volume

1. A test bench of a magnetic field of a sediment core extending along a main direction, wherein the test bench comprises at least:
a movement device for moving the sediment core in translation within the test bench,
a measuring chamber comprising a fluxgate probe arranged to be arranged opposite and preferably in contact with a portion of sediment core so as to measure, perpendicularly to said main direction, a magnetic field generated by said portion of sediment core situated opposite the fluxgate probe;
and that the movement device is configured so as to make the sediment core translate with respect to the fluxgate probe such that the fluxgate probe successively captures the magnetic field of a succession of portions of the sediment core.

2. The test bench according to the claim 1, wherein the fluxgate probe is arranged so as to measure perpendicularly to said main direction, the magnetic field generated by said portion of sediment core situated opposite the fluxgate probe.

3. The test bench according to claim 1, wherein a distance between the fluxgate probe and the portion of sediment core opposite the fluxgate probe is less than or equal to 6 mm (10⁻³ metres), preferably less than or equal to 2 mm, preferably less than or equal to 1 mm, preferably equal to 0 mm.

4. The test bench according to claim 1, wherein the fluxgate probe comprises a core, preferably made of permalloy, and wherein a distances between the core and the portion of sediment core is less than or equal to 6 mm (10⁻³ metres), preferably less than or equal to 2 mm, preferably less than or equal to 1 mm, preferably equal to 0 mm.

5. The test bench according to claim 1, wherein the fluxgate probe is situated vertically below the sediment core when the sediment core is situated partially at least in the measuring chamber.

6. The test bench according to claim 1, configured such that the sediment core translates continuously by passing opposite the fluxgate probe and configured so as to trigger measurements by the fluxgate probe to successively measure the magnetic field of a succession of predefined portions of the sediment core.

7. The test bench according to claim 1, wherein taking measurements by the fluxgate probe is synchronised with a movement in translation of the sediment core so as to trigger a measurement by the fluxgate probe when a movement of the sediment core is completed to bring an elementary volume to the right of the fluxgate probe.

8. The test bench according to claim 1, wherein the measuring chamber comprises a magnetic shield forming a sleeve inside which are situated the fluxgate probe and said portion of sediment core situated opposite the fluxgate probe.

9. The test bench according to claim 8, wherein the magnetic shield comprises at least one sleeve and preferably two concentric sleeves made of mu-metal.

10. The test bench according to claim 1, wherein the movement device comprises a conveyor belt, driven in movement by a motor, and wherein the conveyor belt passes through the measuring chamber.

11. The test bench according to claim 10 wherein the motor is a stepper motor.

12. A device for estimating remanent magnetisations of portions of a sample forming a sediment core of rectangular cross-section (“U-channel”), and extending along a main direction, the device comprising a test bench according to claim 1 and a calculation module arranged to implement at least the following steps:
Defining a succession of N elementary volumes and the dimensions thereof, each elementary volume corresponding to a portion of sediment core (100), the elementary volumes being adjacent and successively arranged along said main direction of the sediment core;
Measuring, by the fluxgate probe, the magnetic field produced by each elementary volume;
By using the magnetic field measurements of the fluxgate probe: determining a remanent magnetisation M₋ₓ specific to each elementary volume, this step comprising at least one from among the following steps;
“directly” identifying a plurality of possible values of remanent magnetisation M₋ₓ, this first identification comprising:
Calculating values of magnetic field B₋ₓ from a plurality of values of remanent magnetisation M₋ₓ selected arbitrarily;
identifying, among said plurality of values of remanent magnetisations M₋ₓ selected arbitrarily, one or more values of remanent magnetisation M₋ₓ for which the magnetic field B₋ₓ calculated is between 0.7 and 1.3 times, preferably between 0.8 and 1.2 times, and preferably between 0.9 and 1.1 times, the magnetic field B₋ₓ measured by the fluxgate probe;
“inversely” identifying one or more values of remanent magnetisation M₋ₓ, this second identification comprising:
calculating a value M₋ₓ of remanent magnetisation according to the measurement of the magnetic field measured by the fluxgate probe.

13. The device according to claim 12, where in the step of determining a remanent magnetisation M₋ₓ specific to each elementary volume comprises at least;
said “direct” identification, and
said “inverse” identification, made after said “direct” identification,
and wherein said “inverse” identification, the calculation of a value M₋ₓ of remanent magnetisation according to the magnetic field measured by the fluxgate probe is made from said one or more possible values of remanent magnetisation M₋ₓ identified coming from the “direct” identification step.

14. A method for estimating the remanent magnetisations of portions of a sediment core extending along a main direction, the method comprising at least the following steps:
i. Defining a succession of N elementary volumes and the dimensions thereof, each elementary volume corresponding to a portion of sediment core, the elementary volumes being adjacent and successively arranged along said main direction of the sediment core;
ii. Translating the sediment core relative to a fluxgate probe so as to make each elementary volume pass opposite the fluxgate probe;
iii. Measuring, by the fluxgate probe, the magnetic field produced by each elementary volume;
iv. By using the magnetic field measurements of the fluxgate probe: determining a remanent magnetisation M₋ₓ specific to each elementary volume (101), this step comprising at least one from among the following steps;
“directly” identifying a plurality of possible values of remanent magnetisation M₋ₓ, this first identification comprising:
Calculating values of magnetic field B₋ₓ from a plurality of values of remanent magnetisation M₋ₓ selected arbitrarily;
identifying, among said plurality of values of remanent magnetisations M₋ₓ selected arbitrarily, one or more values of remanent magnetisation M₋ₓ for which the magnetic field B₋ₓ calculated is between 0.7 and 1.3 times, preferably between 0.8 and 1.2 times, and preferably between 0.9 and 1.1 times, the magnetic field B₋ₓ measured by the fluxgate probe;
“inversely” identifying one or more values of remanent magnetisation M₋ₓ, this second identification comprising:
calculating a value M₋ₓ of remanent magnetisation according to the measurement of the magnetic field measured by the fluxgate probe.

15. The method according to claim 14, wherein the step of determining a remanent magnetisation M₋ₓ specific to each elementary volume comprises at least;
said “direct” identification, and
said “inverse” identification,
and wherein the calculation of said value M₋ₓ of remanent magnetisation according to the magnetic field measured by the fluxgate probe made during said “inverse” identification, is made from said one or more possible values of remanent magnetisation M₋ₓ identified coming from the “direct” identification step.

16. The method according to claim 14, wherein said definition step is carried out such that each elementary volume of sediment core has one same thickness, the thickness being measured along said main direction.

17. The method according to claim 14, wherein said definition step is carried out such that each elementary volume of sediment core has a thickness, independent from that of the other elementary volumes, the thickness being measured along said main direction.

18. The method according to claim 17, wherein the thickness is determined by visual analysis of the core according to a homogeneity criterion.

19. The method according to claim 18, wherein the homogeneity criterion is taken from among: colour and texture.

20. The method according to claim 14 comprising a prior step of providing a sediment core having natural remanent magnetisations, then a step of transforming the remanent magnetisations into artificial remanent magnetisations, said transformation step comprising a passage of the sediment core into a Halbach array.
